(19) United States
(12) Patent Application Publication
(10) Pub. No.: US 2009/0044221 A1
(43) Pub. Date: Feb. 12, 2009

(54) Information Processing Apparatus and Program Startup Control Method

(75) Inventor: Kotaro Fukui, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/171,974

(22) Filed: Jul. 11, 2008

(30) Foreign Application Priority Data
Aug. 6, 2007 (JP) 2007-204607

(51) Int. Cl. G06F 13/00

(52) U.S. Cl. 725/38

(57) ABSTRACT

According to one embodiment, an information processing apparatus includes a CPU, a connector which outputs a video signal and inputs/outputs various commands for operation control, a command transmitting unit which transmits the various commands via the connector, a menu screen display unit which arranges an operation menu on a display screen and transmits a video signal for the display screen via the connector, when a command which requests display of the operation menu dealing with various programs which cause the CPU to perform information processes accompanied by playback of motion picture data as options is received by the command transmitting unit, and a program startup unit which starts up a program corresponding to a selected one of the options when a command which instructs selection of one of the options on the operation menu is received by the command transmitting unit.

### CROSS-REFERENCE TO RELATED APPLICATIONS

This application is based upon and claims the benefit of priority from Japanese Patent Application No. 2007-204607, filed Aug. 6, 2007, the entire contents of which are incorporated herein by reference.

### BACKGROUND

1. Field

One embodiment of the invention relates to an application program startup control technique that is preferably applied to a personal computer having a motion picture playback function capable of transmitting a video signal to a television broadcast receiver, for example.

2. Description of the Related Art

In recent years, personal computers including a function of receiving and processing television broadcasting program data for viewing and playing back audiovisual (AV) content stored on Digital Versatile Discs (DVDs) are widely used. Thus, motion picture data (containing audio) can be utilized while the user is moving or in a position where he has gone to if the user carries a notebook size personal computer that can be battery-driven, for example.

Further, recently, the definition of a video motion picture is further enhanced and personal computers that can play back high-definition motion picture data stored in recording media of an High-Definition (HD) DVD standard start to be widely used. Generally, this type of personal computer has a mechanism of outputting a high-definition video signal to the exterior and, for example, the user can enjoy a high-definition video motion picture played back by the personal computer on a large-screen high-definition television broadcast receiver by connecting the personal computer to the large-screen high-definition television broadcast receiver when he is at home, for example.

For example, when a plurality of electronic devices are connected each other, for example, in a case where the personal computer is connected to the television broadcast receiver and if all of the electronic devices can be operated by operating one of the electronic devices, the usability thereof can be extremely enhanced (by taking utilization of a remote controller into consideration, for example). Based on the above fact, for example, various proposals associated with a mechanism for performing the operation for a certain electronic device on a different electronic device are made (for example, refer to Jpn. Pat. Appln. KOKAI Publication No. 2004-201215).

If the conventional method including the method disclosed in Jpn. Pat. Appln. KOKRI Publication No. 2004-201215 is applied, it seems possible to turn ON the power source of a personal computer connected to a television broadcast receiver via a cable by performing the operation for the television broadcast receiver.

The personal computer is used for various purposes, for example, for formation of documents and calculations based on a spreadsheet in addition to playback of AV content. That is, various software programs are installed. Therefore, when a mechanism for starting up a software program installed in the personal computer by performing an operation for the television broadcast receiver is configured, it is required to take a user friendly measure so that a desired software program (having a meaning when the personal computer is connected to the television broadcast receiver) can be efficiently selected from the various software programs and started up.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an application configuration of an information processing apparatus (personal computer) according to the embodiment of the invention;

FIG. 2 is an exemplary diagram showing a first display screen for schematically illustrating a program startup control operation performed by the information processing apparatus of the embodiment;

FIG. 3 is an exemplary diagram showing a second display screen for schematically illustrating a program startup control operation performed by the information processing apparatus of the embodiment;

FIG. 4 is an exemplary diagram showing a third display screen for schematically illustrating a program startup control operation performed by the information processing apparatus of the embodiment;

FIG. 5 is an exemplary diagram showing the configuration of the information processing apparatus of the embodiment;

FIG. 6 is an exemplary diagram showing a function block relating to the program startup control operation performed by the information processing apparatus of the embodiment; and

FIG. 7 is an exemplary flowchart showing the operation procedure of the program startup control operation performed by the information processing apparatus of the embodiment in cooperation with a video apparatus externally connected thereto.

### DETAILED DESCRIPTION

Various embodiments according to the invention will be described hereinafter with reference to the accompanying drawings. In general, according to one embodiment of the invention, an information processing apparatus includes a CPU, a connector which outputs a video signal and inputs/outputs various commands for operation control, a command transmitting unit which transmits the various commands via the connector, a menu screen display unit which arranges an operation menu on a display screen and transmits a video signal for the display screen via the connector, when a command which requests display of the operation menu dealing with various programs which cause the CPU to perform information processes accompanied by playback of motion picture data as options is received by the command transmitting unit, and a program startup unit which starts up a program corresponding to a selected one of the options when a command which instructs selection of one of the options on the operation menu is received by the command transmitting unit.

In FIG. 1, one example of the application configuration of an information processing apparatus according to the present embodiment is shown. The information processing apparatus a is realized as a notebook size personal computer (PC), for example.

In this case, as shown in FIG. 1, a case wherein the information processing apparatus 1 is connected to a video apparatus 2 via a high-definition multimedia interface (HDMI) cable “A” is assumed. The video apparatus 2 is a large-screen high-definition television broadcast receiver (TV) and can be remotely operated by means of a remote controller 3. In the information processing apparatus 1, various software programs (application programs) used to play back high-definition motion picture data are installed and the user can enjoy a high-definition motion picture played back by the application programs by means of the video apparatus 2 by connecting the same via the HDMI cable “A”.

Further, the information processing apparatus 1 and video apparatus 2 that are connected to each other via the HDMI cable “A” can mutually transmit various types of commands that are used to control the operations of the connected partners. That is, it is possible to operate the information processing apparatus 1 by performing the operation for the video apparatus 2 using the remote controller 3. The information processing apparatus 1 of the present embodiment provides a mechanism for permitting the user to efficiently select and start up an application program (associated with the video apparatus 2) using the remote controller 3 used to remotely operate the video apparatus 2. This is explained in detail below.

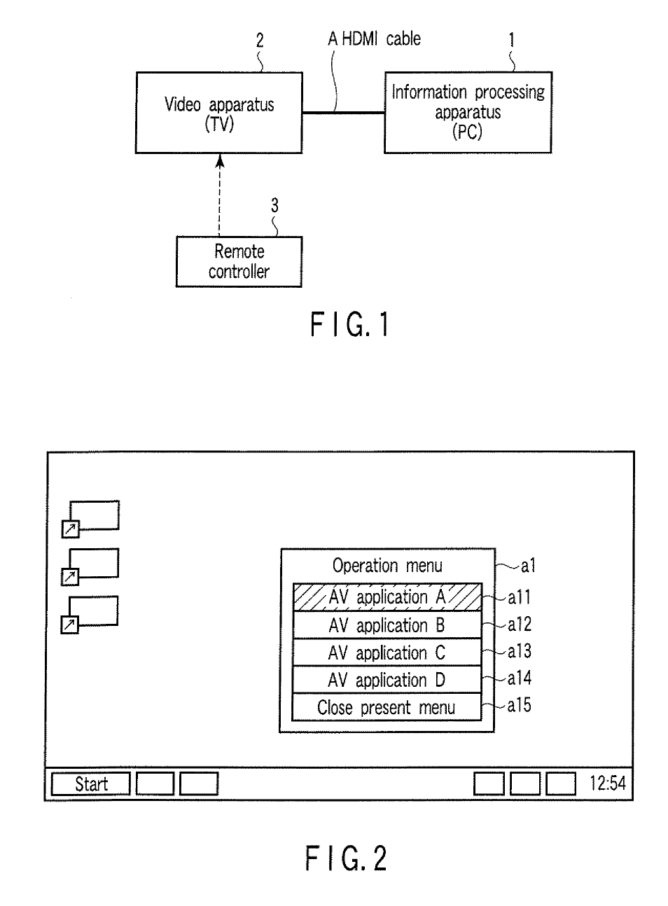

First, with reference to FIGS. 2 to 4, the mechanism that is provided by the information processing apparatus 1 and permits the user to efficiently select and start up an application program (associated with the video apparatus 2) using the remote controller 3 is schematically explained.

When the power source of the video apparatus 2 is turned on by the remote controller 3 and the input system of the video apparatus 2 is switched to the HDMI cable “A”, that is, to the information processing apparatus 1, a power-on request command is transmitted from the video apparatus 2 to the information processing apparatus 1. The information processing apparatus 1 can receive a command transmitted via the HDMI cable “A” while the power source thereof is set off and the power source thereof is turned on when receiving the command.

The remote controller 3 has a preset button for displaying a list (which is hereinafter referred to as an operation menu) in which application programs installed in the information processing apparatus 1 to play back high-definition motion picture data are displayed as options. When the button is pressed, a command for requesting display of the operation menu is transmitted from the video apparatus 2 to the information processing apparatus 1. The operation menu that displays the application programs used to play back high-definition motion picture data in a list form as options is previously defined. When receiving the command, the information processing apparatus 1 arranges the operation menu on the display screen and transmits a video signal for the display screen to the video apparatus 2. Thus, the display screen having an operation menu a1 arranged on a so-called desktop as shown in FIG. 2 is displayed on the video apparatus 2.

As shown in FIG. 2, options a11 to a14 used to start up one of four programs of AV applications “A” to “D” and an option a15 used to close the operation menu a1 are displayed in a list form on the operation menu a1. The AV applications “A” to “D” are programs to perform information processes accompanied by playback of motion picture data, for example, a program used to play back television broadcasting program data recorded, a program used to acquire moving picture stream data via a network such as Internet and play back the same, a program used to play back AV content stored in recording media such as HD DVDs and the like (or may be a program that permits a hardware such as an LSI to play back motion picture data and performs the control operation thereof). That is, each of the above programs has a meaning when the information processing apparatus 1 capable of outputting a video signal to the video apparatus 2 via the HDMI cable “A” is connected to the video apparatus 2.

Various types of programs are installed in the information processing apparatus 1 which is a personal computer. If a mechanism for displaying the operation menu a1 selected from the above programs to start up the AV applications “A” to “D” based on the command from the video apparatus 2 is provided, the usability thereof by the user who operates the remote controller 3 to enjoy video motion pictures by means of the video apparatus 2 can be extremely enhanced.

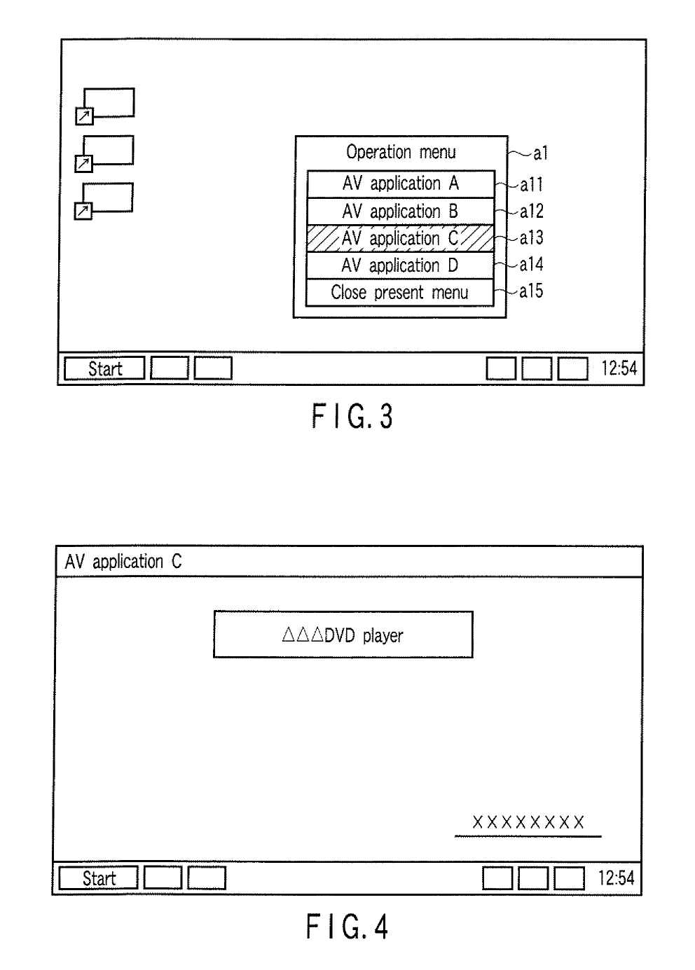

For example, when the AV application “C” among the applications “A” to “D” is a program that plays back AV content stored in a recording medium and the AV content stored in the recording medium received in a recording medium drive device is played back, the user operates, for example, a cross-shaped key (presses the downward button twice) provided on the remote controller 3 to transmit the selection state from option a11 to option a13. The operation contents are transmitted as a command from the video apparatus 2 to the information processing apparatus 1 and update the display state of the operation menu a1 to display the state in which option a13 is selected in the information processing apparatus 1. As a result, the display screen of the video apparatus 2 is updated as shown in FIG. 3.

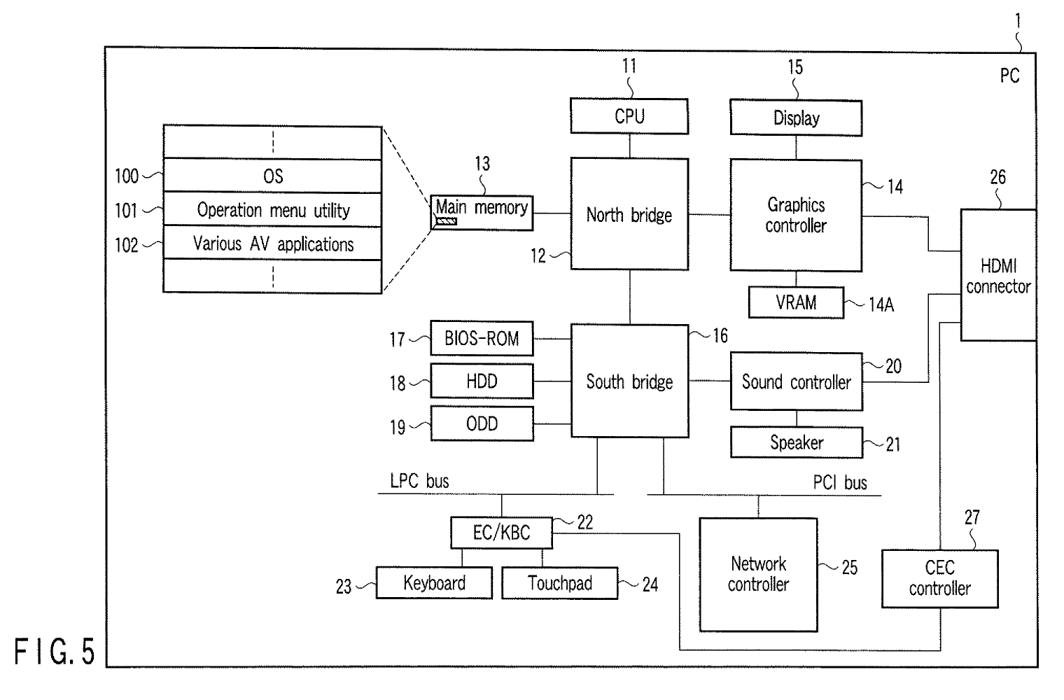

Next, the user operates, for example, a determination key provided on the remote controller 3 to determine selection of option a13. The selection instruction is also transmitted as a command from the video apparatus 2 to the information processing apparatus 1 and the information processing apparatus 1 starts up a program (AV application) corresponding to option a13. Further, the user selects option a15 by the same operation as the selection operation for option a13 to give an instruction of closing the operation menu a1 to the information processing apparatus 1. Thus, as shown in FIG. 4, a video motion picture of the desired AV application “C” can be simply displayed on the display screen of the video apparatus 2.

FIG. 5 is an exemplary diagram showing the configuration of the information processing apparatus 1. As shown in FIG. 5, the information processing apparatus 1 includes a CPU 11, north bridge 12, main memory 13, graphics controller 14, VRAM 14A, display 15, south bridge 16, BIOS-ROM 17, hard disk drive (HDD) 18, magnet-optical disk drive (ODD) 19, sound controller 20, speaker 21, embedded controller/keyboard controller (EC/KBC) 22, keyboard 23, touchpad 24, network controller 25, HDMI connector 26, consumer electronics control (CEC: device-device bidirectional) controller 27 and the like.

The CPU 11 is a processor that controls the operations of the respective portions in the information processing apparatus 1. The CPU 11 executes an operating system (OS) 100 that is loaded from the HDD 18 into the main memory 13 and various programs, that is executed under the control of the OS 100, containing an operation menu utility 101 that is a utility to perform the control operation for the operation menu a1 and various AV applications 102 accompanied by playback of motion picture data. Further, the CPU 11 executes a basic input/output system (BIOS) stored in the BIOS-ROM 17. In the following explanation, the basic input/output system itself stored in the BIOSROM 17 is referred to as the BIOS 17 in some cases.

The north bridge 12 is a bridge device that connects the local bus of the CPU 11 with the south bridge 16. The north bridge 12 has a function of communicating with the graphics controller 14 via a bus and contains a memory controller that controls access to the main memory 13. The graphics controller 14 is a display controller that controls the display 15 on the information processing apparatus 1 side. The graphics controller 14 generates a video signal to be output to the display 15 based on motion picture data written into the VRAM 14A. Further, the graphics controller 14 has a function of outputting the video signal to the exterior from the HDMI connector 26.

The south bridge 16 is a controller that controls various devices on a PCI bus and LPC bus. Further the south bridge 16 is directly connected to the BIOS-ROM 17, HDD 18, ODD 19 and sound controller 20 and has a function of controlling the above portions. For example, television broadcasting program data and AV content and the like downloaded via the Internet is stored in the HDD 18 and an HD DVD in which AV content is stored is received in the ODD 19, for example. The sound controller 20 is a sound source controller that controls the speaker 21. The sound controller 20 has a function of outputting a voice signal to the exterior from the HDMI connector 26.

The ESC/KBC 22 is a one-chip microcomputer obtained by integrating an embedded controller for power management and a keyboard controller that controls the keyboard 23 and touchpad 24. The network controller 25 is a communication device that communicates with an external network such as the Internet, for example. The EC/KBC 22 is operated while the power source of the information processing apparatus 1 is kept off and monitors whether the power-on operation is performed or not, for example. Then, if an event suggesting that the power source is to be turned on occurs, it performs the control operation to activate the information processing apparatus 1. Further, the EC/KBC 22 continuously supplies power to the CEC controller 27 while the power source of the information processing apparatus 1 is kept off.

The HDMI connector 26 is a terminal to which the HDMI cable “A” is detachably connected. The CEC controller 27 performs a data transmit control operation to transmit various commands for operation control via the HDMI connector 26 under the control of the EC/KBC 22. As one of the events for turning on the power source that is monitored by the EC/KBC 22, an event of receiving a power-on request command by the CEC controller 27 is provided.

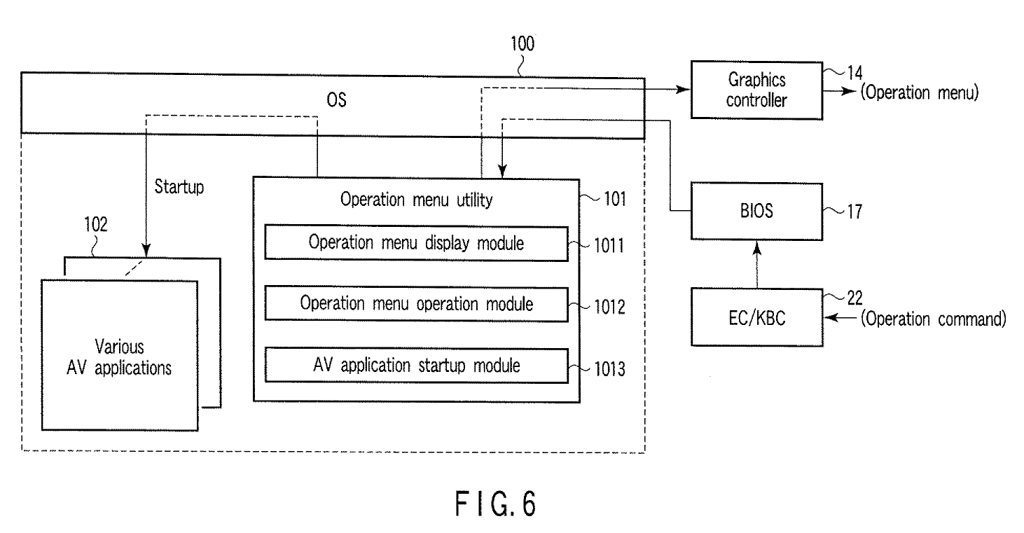

FIG. 6 is an exemplary diagram showing a function block associated with a program startup control operation realized in the information processing apparatus 1 with the above configuration.

As described above, if an operation of displaying the operation menu a1 (pressing of a preset button provided on the remote controller 3) is performed by means of the video apparatus 2 connected via the HDMI cable “A”, a command that requests the display of the operation menu a1 is transmitted. The command is guided into the information processing apparatus 1 via the HDMI connector 26 and received by the CEC controller 27 and reception of the command is notified to the EC/KBC 22.

When receiving the notification, the EC/KBC 22 generates the same key code as that generated when the keyboard 23 is operated to start up the operation menu utility 101. The key code is transmitted to the OS 100 via the BIOS 17. The OS 100 makes recognition as if an input for requesting the startup of the operation menu utility 101 is made by the keyboard 23 and starts up the requested operation menu utility 101.

The operation menu utility 101 thus started up has an operation menu display module 1011, operation menu operation module 1012 and AV application startup module 1013.

The operation menu display module 1011 is operated at the startup time of the operation menu utility 101. Then, it requests the OS 100 to acquire a display area (window) of the operation menu a1 and, at the same time, requests the OS 100 to display the previously defined operation menu a1 (into the thus acquired display area). As a result, the display screen shown in FIG. 2 is displayed. In a case where the EC/KBC 22 activates the information processing apparatus 1 when the CEC controller 27 receives a power-on request command, the EC/KBC 22 outputs a video signal for a display screen to the graphics controller 14 only via the HDMI connector 26 and transmits a control signal to the display 15 to set the operation thereof so as not to display the video signal. As a result, the display screen on which the operation menu al is arranged is displayed only on the video apparatus 2 side to which the user pays much attention. Further, a motion picture played back by the AV application 102 which will be described later is displayed only on the video apparatus 2 side.

After the operation menu a1 is displayed on the video apparatus 2, a command transmitted by operating the cross-shaped key or determination key of the remote controller 3 is notified to the EC/KBC 22 via the HOMI connector 26 and CEC controller 27. Then, the EC/KBC 22 replaces the command by a key code generated when an arrow key or enter key on the keyboard 23 is pressed. At this time, since the operation menu utility 101 is set in the active state, the above key codes are supplied to the operation menu utility 101 as input data after they are transmitted from the BIOS 17 to the OS 100.

When a key code indicating pressing of the arrow key, for example, is given as input data, the operation menu operation module 1012 performs a process of updating the display state of the operation menu al to change the selection state of options a11 to a15 of the operation menu al. Further, when a key code indicating pressing of the enter key is given as input data while option a15 (“close present menu”) is selected, it performs a process of terminating the operation menu utility 101.

Further, when a key code indicating pressing of the enter key is given as input data while one of options a11 to a14 is selected, the AV application startup module 1013 requests the OS 100 to start up the AV application 102 corresponding to the selected option. As a result, a desired program is started up on the information processing apparatus 1.

Thus, the information processing apparatus 1 is designed to have a mechanism for displaying the operation menu a1 that deals with only the AV applications “A” to “D” associated with the video apparatus 2 connected thereto via the HDMI cable “A” (and performing the information process accompanied by playback of motion picture data) as options. Further, the mechanism starts up the AV applications “A” to “D” on the operation menu a1. Thus, the usability of the video apparatus 2 by the user who operates the remote controller 3 (for the video apparatus 2) to enjoy a video motion picture on the video apparatus 2 can be extremely enhanced.

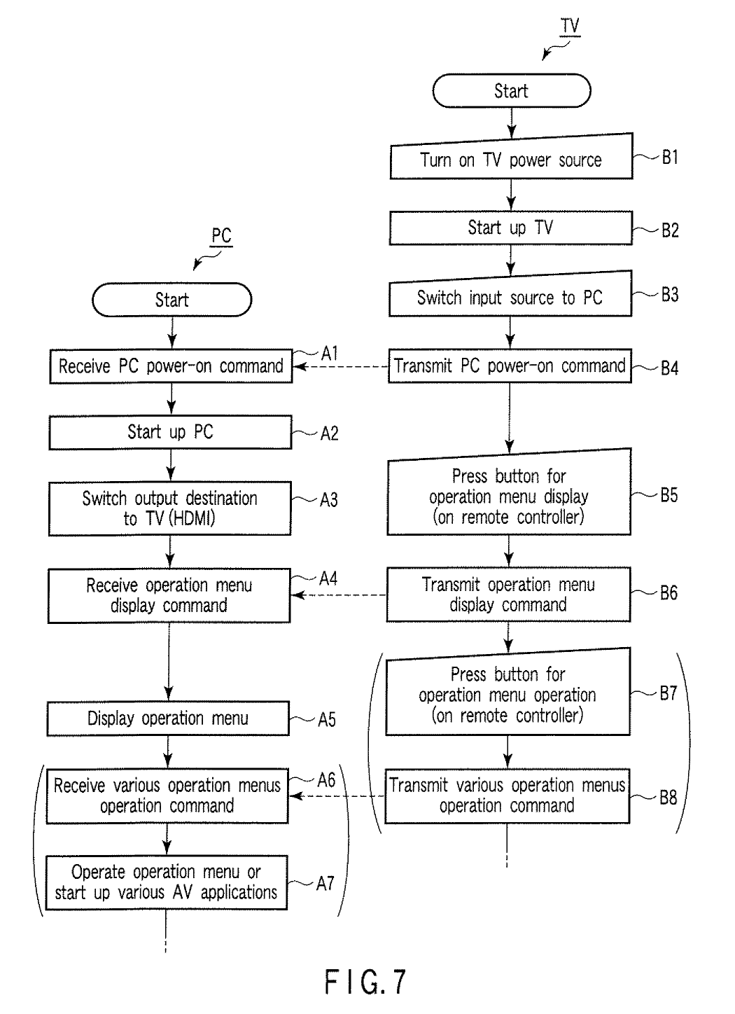

FIG. 7 is an exemplary flowchart showing the operation procedure of the program startup control operation performed by the information processing apparatus 1 of the present embodiment in cooperation with the video apparatus 2 connected thereto via the HDMI cable “A”.

When an operation of turning on the power source of the video apparatus 2 is performed by means of the remote controller 3 (block B1), first, the power source of the video apparatus 2 is turned on (block B2). Then, when an operation of switching the input system of the video apparatus 2 to the information processing apparatus 1 is performed by means of the remote controller 3 (block B3), a command that requests the information processing apparatus 1 to turn on the power source thereof is issued from the video apparatus 2 (block B4).

When receiving the power-on request command (block A1), the information processing apparatus 1 turns on the power source of the information processing apparatus 1 (block A2). At this time, a setup is made to output a video motion picture only to the HDMI connector 26 (block A3). After this, when an operation of displaying the operation menu a1 is performed by means of the remote controller 3 (block B5), a command that requests display of the operation menu a1 is transmitted between the video apparatus 2 and the information processing apparatus 1 (blocks B6 and A4).

The information processing apparatus 1 that has received the command displays the operation menu a1 (block A5) and waits for transmission of a command from the video apparatus 2. On the video apparatus 2 side, a command is transmitted to the information processing apparatus 1 in response to the operation of the remote controller 3 (blocks B7 and B8). Then, the information processing apparatus 1 updates the operation menu a1 and starts up various AV applications based on the command transmitted from the video apparatus 2 (blocks A6 and A7).

As described above, according to the information processing apparatus 1 of the present embodiment, a desired program associated with the video apparatus 2 is efficiently selected and started up on the video apparatus 2 side connected thereto via the HDMI cable “A”.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a CPU;
a connector which outputs a video signal and inputs/outputs various commands for operation control;
a command transmitting unit configured to transmit the various commands via the connector;
a video signal transmitting unit configured to transmit a video signal for a screen on which an operation menu dealing with various programs as options is arranged when a command requesting display of the operation menu is received by the command transmitting unit, the various programs cause the CPU to perform information processes accompanied by playback of motion picture data; and
a program startup unit configured to start up a program corresponding to a selected one of the options when a command instructing selection of one of the options on the operation menu is received by the command transmitting unit.

2. The information processing apparatus according to claim 1, further comprising:
a display controller which controls output of the video signal for the screen via the connector and display of the video signal by a display device; and
a control unit configured to control the display controller only to output the video signal for the screen on which the operation menu is arranged via the connector and not to display the video signal by the display device.

3. The information processing apparatus according to claim 2, wherein the control unit includes a activating unit configured to activate the information processing apparatus when the command transmitting unit receives a power-on request command,
the control unit controlling the display controller to set an output destination of the video signal for the screen only to the connector when the information processing apparatus is activated by the activating unit.

4. The information processing apparatus according to claim 1, wherein the connector is detachably connected to a high-definition-multimedia interface (HDMI) cable.

5. The information processing apparatus according to claim 1, further comprising a keyboard controller which controls the keyboard,
the keyboard controller transmitting a command, the command being received by the command transmitting unit and instructing selection of one of options on a menu screen, to the program startup unit as a key code generated when a preset key on the keyboard is pressed.

6. A program startup control method of an information processing apparatus including a CPU, a connector which outputs a video signal and inputs/outputs various commands for operation control and a command transmitting unit configured to transmit the various commands via the connector, the method comprising:
transmitting a video signal for a screen on which an operation menu dealing with various programs as options is arranged when a command requesting display of the operation menu is received by the command transmitting unit, the various programs cause the CPU to perform information processes accompanied by playback of motion picture data; and
starting up a program corresponding to a selected one of the options when a command instructing selection of one of the options on the operation menu is received by the command transmitting unit.

7. The program startup control method according to claim 6, wherein the information processing apparatus includes a display controller which controls output of the video signal for the display screen via the connector and display of the video signal by a display device, and
the method further comprising controlling the display controller only to output the video signal for the screen on which the operation menu is arranged via the connector and not to display the video signal by the display device when the video signal is transmitted via the connector.

8. The program startup control method according to claim 7, further comprising controlling the display controller to set an output destination of the video signal for the screen only to the connector when the information processing apparatus is activated in response to reception of a power-on request command.
